(19) United States
(12) Patent Application Publication
(10) Pub. No.: US 2010/0275257 A1
(43) Pub. Date: Oct. 28, 2010

(54) ELECTRONIC DEVICE

(75) Inventor: Tsuyoshi Nishida, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/714,292

(22) Filed: Feb. 26, 2010

(30) Foreign Application Priority Data
Apr. 28, 2009 (JP) 2009-109334

(51) Int. Cl. G06F 7/04

(52) U.S. Cl. 726/19

(57) ABSTRACT

According to one embodiment, an electronic device includes a receiver, a selector, a converter, and an authentication module. The receiver receives data on a password input through a keyboard. The selector selects one of key layouts of different keyboards. The converter converts the data on the password received through the keyboard to a password character string according to the one of the key layouts. The authentication module determines that the password is authenticated when information based on the password character string obtained by the converter for the one of the key layouts matches information based on a registered password character string.

### CROSS-REFERENCE TO RELATED APPLICATIONS

This application is based upon and claims the benefit of priority from Japanese Patent Application No. 2009-109334, filed on Apr. 28, 2009, the entire contents of which are incorporated herein by reference.

### BACKGROUND

1. Field

One embodiment of the invention relates to an electronic device that uses password authentication.

2. Description of the Related Art

A keyboard has been used as an input device of an electronic device such as a personal computer (PC). Characters including numbers, letters, and specific symbols are printed on the keys of the keyboard, respectively. When a key is pressed, the keyboard notifies the system of not the character code of a character printed on the key but abstract information (hereinafter, “scan code” as referred to in PC terminology).

The keys include shift keys (left shift key, right shift key, left Alt key, right Alt key, left control key, right control key, etc.). By a combination of a shift key and another key, the user can switch input characters. Hereinafter, state of the shift keys (information indicating which shift key is being pressed) will be referred to as “shift key state”.

The key layout, i.e., character layout, of the keyboard may vary according to the difference in language or the like. Therefore, there is the case that different characters are printed on keys of different keyboards that generate the same scan code due to the difference in the key layout. Incidentally, although a scan code is also assigned to each of the shift keys, it does not depend on the key layout. Similarly, a scan code assigned to Backspace key, Delete key, Enter key, and the like does not depend on the key layout.

For this reason, to obtain the character code of a character printed on a key based on the scan code of the key, information on the key layout and the shift key state is required in addition to the scan code. Accordingly, the system that receives input from the keyboard has a mechanism to convert a scan code to a character code based on the information.

In general, password authentication is performed on a system or the like that is used by a plurality of users. A password character string is not displayed as it is on the password authentication screen but is displayed with obscuring characters such as asterisks (*). As a result, the user cannot distinguish whether the system uses a combination of a scan code and shift key state or a character code as an internal expression of a password.

Besides, the user only knows a character string reported (or set him/herself) as a password and has no idea about the actual internal expression or notation of the password in the system. For example, Japanese Patent Application Publication (KOKAI) No. 2007-122262 discloses a conventional password converter that converts an input password to another password. More specifically, the conventional password converter converts an input password to another password according to conversion rules and feeds the converted password to software. The user has no way to know that such password conversion is internally performed.

Even if the system does not use such a specific conversion as performed by the conventional password converter or specific internal expression, the user may input a character string that is correct as a password through a different keyboard than the one with a preset key layout. In this case, the system is notified of an incorrect scan code due to the difference in key layout, and accordingly, the system may not properly authenticate the password.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of a notebook personal computer (PC) according to a first embodiment of the invention;

FIG. 2 is an exemplary block diagram of a hardware configuration of the notebook PC in the first embodiment;

FIG. 3 is an exemplary block diagram of a software configuration for a password authentication process in the first embodiment;

FIG. 4 is an exemplary flowchart of the password authentication process (password authentication routine) performed by the notebook PC in the first embodiment;

FIG. 5 is an exemplary table in which a scan code and shift key state are associated with a character code with respect to each type of key layout in the first embodiment;

FIG. 6 is an exemplary block diagram of a software configuration for a password registration process according to a second embodiment of the invention;

FIG. 7 is an exemplary flowchart of the password registration process (password registration routine) performed by the notebook PC in the second embodiment;

FIG. 8 is an exemplary view of an option setting screen according to a third embodiment of the invention.

### DETAILED DESCRIPTION

Various embodiments according to the invention will be described hereinafter with reference to the accompanying drawings. In general, according to one embodiment of the invention, an electronic device comprises a receiver, a selector, a converter, and an authentication module. The receiver is configured to receive data on a password input through a keyboard. The selector is configured to select one of key layouts of different keyboards. The converter is configured to convert the data on the password received through the keyboard to a password character string according to the one of the key layouts. The authentication module is configured to determine that the password is authenticated when information based on the password character string obtained by the converter for the one of the key layouts matches information based on a registered password character string.

According to another embodiment of the invention, an electronic device comprises a receiver, a selector, a converter, and an registration module. The receiver is configured to receive data on a password input through a keyboard. The selector is configured to select one of key layouts of different keyboards. The converter is configured to convert the data on the password received through the keyboard to password character strings according to the key layouts, respectively. The registration module is configured to register information based on each of the password character strings obtained by the converter for the key layouts as a valid password corresponding to the password received by the receiver.

A description will now be given of a personal notebook computer (PC) 100 as an electronic device according to a first embodiment of the invention. Although the electronic device will be described by way of example as a notebook PC, it may be any electronic device or system that performs password authentication such as a desktop PC or a work station.

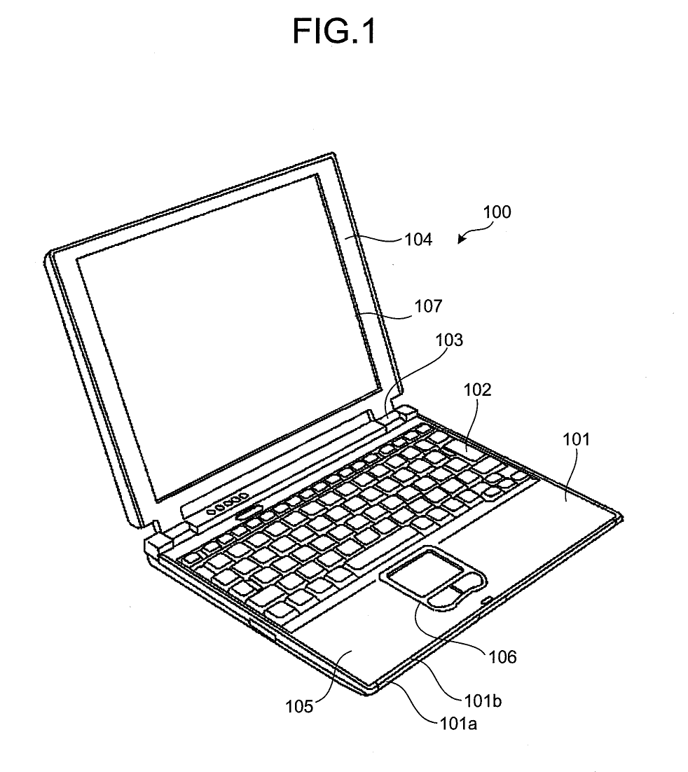

FIG. 1 is a perspective view of the notebook PC 100 of the first embodiment. As illustrated in FIG. 1, the notebook PC 100 is of basically the same configuration as a conventional notebook PC. The notebook PC 100 comprises a housing 101, a keyboard 102, and a panel-side housing 104. The keyboard 102 is arranged on the housing 101. The panel-side housing 104 is rotatably connected to the housing 101 through a hinge 103. The housing 101 comprises an upper case 101a and a lower case 101b. A palm rest 105 is formed in the front portion of the upper surface of the upper case 101a. A touchpad 106 is provided at substantially the center of the palm rest 105. In the center of the panel-side housing 104 is provided a flat panel display 107 for display.

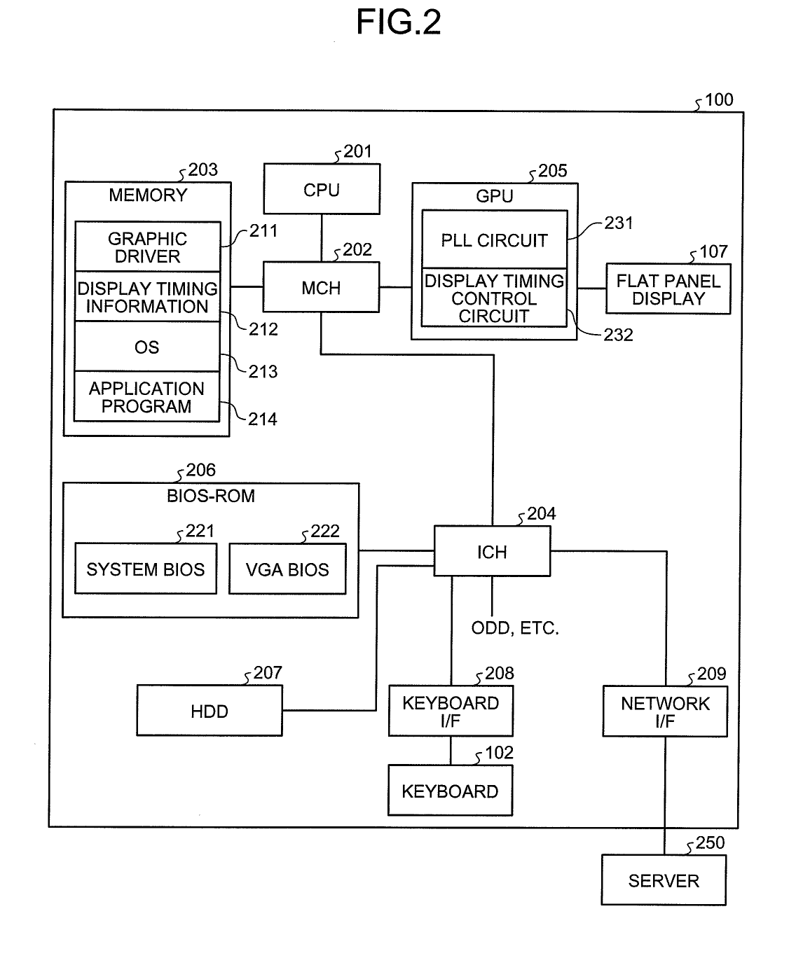

With reference to FIG. 2, a hardware configuration of the notebook PC 100 will be described. As illustrated in FIG. 2, the notebook PC 100 comprises a central processing unit (CPU) 201, a memory controller hub (MCH) 202, a memory 203 as a main storage device, an input/output controller hub (ICH) 204, a graphics controller (graphics processing unit (GPU)) 205, a BIOS-ROM 206, a hard disk drive (HDD) 207 as an auxiliary storage device, the flat panel display 107, a keyboard interface (I/F) 208, and a network I/F 209. Although not illustrated, the ICH 204 is connected to various types of peripheral devices such as an optical disc drive (ODD). While HDD is described herein as an auxiliary storage device, the auxiliary storage device is not limited to HDD and may be any storage device.

The CPU 201 is a processor that controls the overall operation of the notebook PC 100. The CPU 201 executes an operating system (OS) 213 and an application program 214 loaded from the HDD 207 into the memory 203. The CPU 201 also executes a system basic input-output system (BIOS) 221 and a video graphics array basic input-output system (VGA BIOS) 222 stored in the BIOS-ROM 206 and the like. The system BIOS 221 is a program for hardware control, while the VGA BIOS 222 is a program for display control.

The MCH 202 is a bridge that connects between a local bus of the CPU 201 and the ICH 204. The MCH 202 comprises a built-in memory controller that controls access to the memory 203. The MCH 202 has the function of communicating with the graphics controller 205 via an accelerated graphics port (AGP) bus, a peripheral component interconnect (PCI) express serial bus, or the like.

The graphics controller 205 controls display on the flat panel display 107 used as a display device of the notebook PC 100 such as a liquid crystal display (LCD).

The graphics controller 205 comprises a phase locked loop (PLL) circuit 231 and a display timing control circuit 232, and is connected to the flat panel display 107. The PLL circuit 231 is capable of generating an arbitrary pixel clock (operation frequency) and also switching one operation frequency to another in response to a request to change the operation frequency.

The display timing control circuit 232 generates a display signal based on display timing information 212 indicated by a graphic driver 211 in response to a request from the OS 213 or the application program 214. The display timing control circuit 232 feeds the display signal to the flat panel display 107 to display an image thereon.

The ICH 204 controls each device on a low pin count (LPC) bus as well as each device connected to a PCI bus. The ICH 204 comprises a built-in integrated drive electronics (IDE) controller to control the HDD 207. Besides, as illustrated in FIG. 2, the ICH 204 is connected to the keyboard I/F 208 that receives input from the keyboard 102 (or an external keyboard).

The network I/F 209, which is connected to the ICH 204, is an interface to connect to a server 250 via a network such as the Internet. Through the network I/F 209, the notebook PC 100 can download a desired program, content, etc. from the server 250 and the like. When user authentication (password authentication) is performed on the server 250, information on a password provided by the user is transmitted to the server 250 via the network I/F 209.

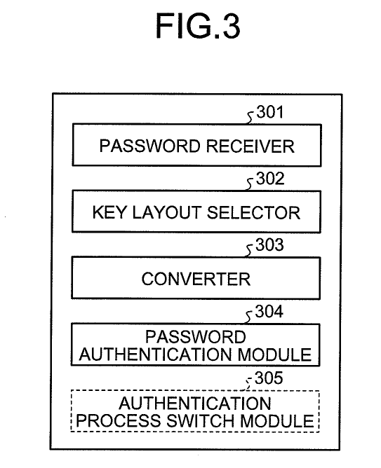

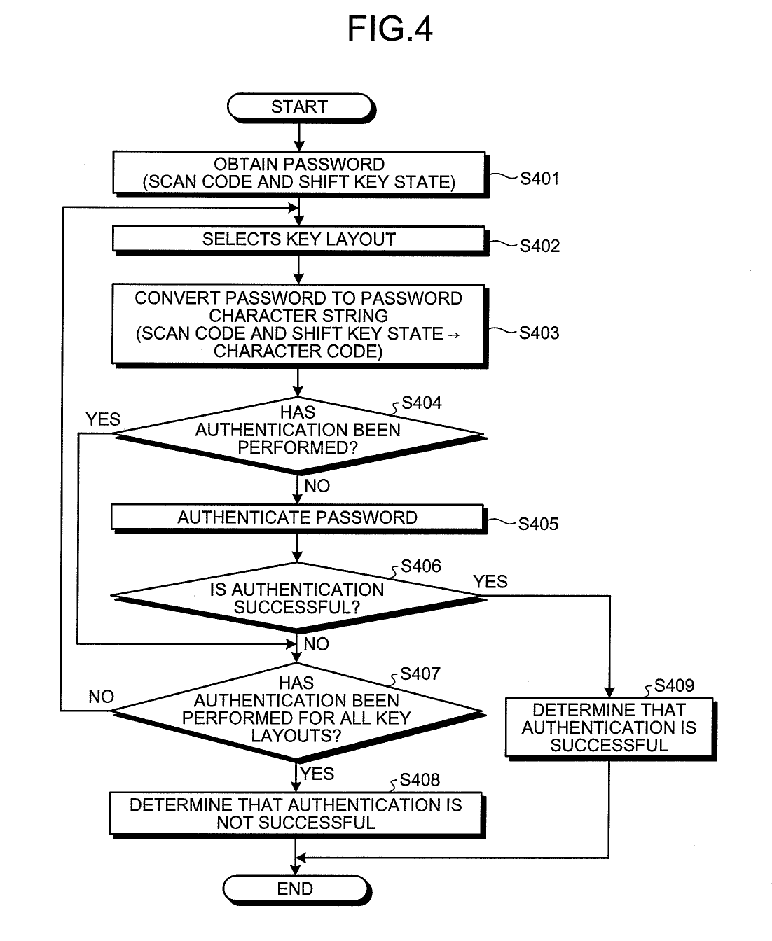

With reference to FIGS. 3 and 4, a description will then be given of a password authentication process performed by the notebook PC 100. FIG. 3 is a block diagram of a software configuration for the password authentication process according to the first embodiment. FIG. 4 is a flowchart of the password authentication process (password authentication routine) performed by the notebook PC 100. In the following, the password authentication process is described as being implemented by the password authentication routine performed by the CPU 201 of the notebook PC 100. However, if the password authentication process is performed on an external system such as a server, information on a password is transmitted from the notebook PC 100 to the external system such that the CPU of the external system can perform the password authentication process based on the information.

The password authentication routine may be implemented by any of the system BIOS, OS, application program of the notebook PC 100 and an external system. If the password authentication routine is implemented by the application program, it is necessary to inquire about a scan code corresponding to the character code of a password provided by the OS to obtain it. As in a conventional manner, a password is managed with respect to each user ID. The password authentication process is described below as being performed for a certain user ID.

As illustrated in FIG. 3, the software configuration that implements the password authentication routine comprises a password receiver 301, a key layout selector 302, a converter 303, and a password authentication module 304. The password receiver 301 receives password data (scan data and shift key state) provided by the user through the keyboard 102. The key layout selector 302 selects key layouts of various types of keyboards. The converter 303 converts the password data received through the keyboard 102 to a password character string according to each key layout. The password authentication module 304 determines that password authentication is successful when information based on the password character string obtained by the converter 303 for the key layout (for example, the password character string itself or a hash value thereof) matches information based on a registered password character string. While FIG. 3 illustrates an authentication process switch module 305 that switches between the password authentication process of the first embodiment and a conventional password authentication process, the authentication process switch module 305 will be described later in another embodiment. The CPU 201 that performs the password authentication routine implements the functions of the above modules.

The password authentication process of the first embodiment will be described in detail with reference to FIG. 4.

First, a password authentication screen is displayed on the flat panel display 107 to receive input of a password from the user (S401). In the first embodiment, the CPU 201 functioning as the password receiver 301 obtains the password input through the keyboard 102 as a string of a combination of a scan code and shift key state.

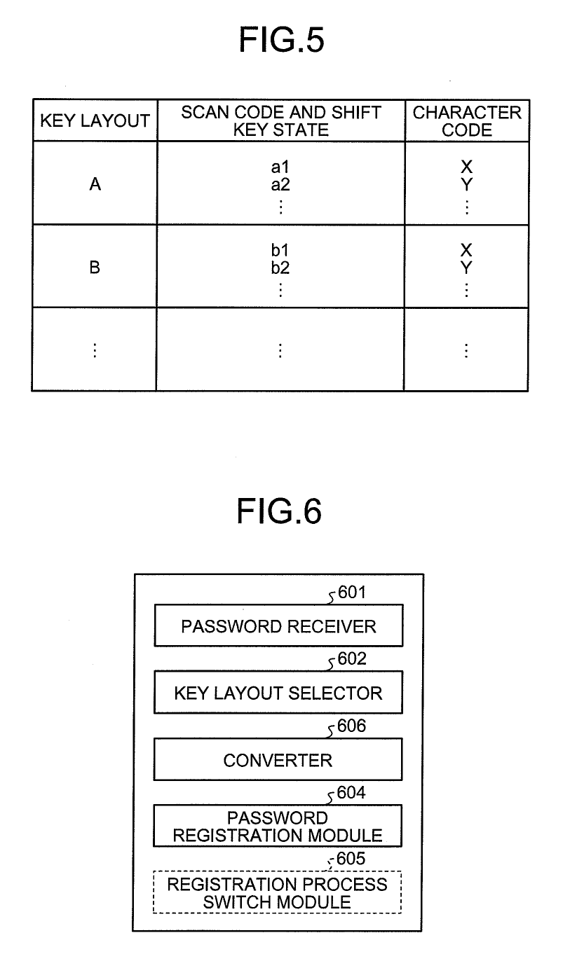

The CPU 201 functioning as the key layout selector 302 selects a key layout (S402). More specifically, the CPU 201 select one key layout from US layout, JIS layout, German layout, and the like. The system BIOS, OS, or application program that implements the password authentication routine is provided with a table (see FIG. 5) in which a scan code and shift key state are associated with a character code with respect to each type of key layout. At S402, the CPU 201 selects one of key layouts stored in the table.

Thereafter, the CPU 201 functioning as the converter 303 converts the password (a string of a combination of a scan code and shift key state) obtained at S401 to a password character string formed of a character code string based on the table as illustrated in FIG. 5 (S403). The three factors, i.e., scan code, shift key state, and key layout, enables the process at S403.

The CPU 201 functioning as the password authentication module 304 determines whether the password character string generated at S403 has already been authenticated at S405 described below (S404). If the password character string has already been authenticated (Yes at S404), the process moves to S407. On the other hand, if the password character string is yet to be authenticated (No at S404), the process moves to S405. At the first determination, since password authentication has not yet been performed at S405, the CPU 201 determines that the password character string is yet to be authenticated (No at S404), and the process moves to S405.

The CPU 201 functioning as the password authentication module 304 compares the password character string generated at S403 with a registered password character string (S405). For example, the CPU 201 compares the hash value of the password character string with that of a password registered in the system or the device. If they match as a result of the comparison, the CPU 201 determines that authentication is successful.

If the CPU 201 functioning as the password authentication module 304 determines that authentication is successful (Yes at S406), the process moves to S409. On the other hand, if the CPU 201 determines that authentication is not successful (No at 5406), the process moves to S407.

The CPU 201 functioning as the password authentication module 304 then determines, based on key layout information (see FIG. 5), whether authentication has been performed for all the key layouts (S407). If authentication has not been performed for all the key layouts (No at S407), the process returns to S402 to select a key layout for which authentication has not yet been performed. On the other hand, if authentication has been performed for all the key layouts (Yes at S407), the process moves to S408.

At S408, the CPU 201 determines that authentication is not successful, and the process ends. On the other hand, at S409, the CPU 201 determines that authentication is successful, and the process ends.

As described above, according to the first embodiment, an input password is authenticated based on a password character string converted from the password with respect to each of all key layouts stored in the notebook PC 100 (or an external system if the password authentication process is performed on the external system). Thus, a password can be authenticated properly regardless of the key layout of a keyboard used by the user.

In the following, a second embodiment of the invention will be described. In the first embodiment, key layouts are switched during password authentication. On the other hand, according to the second embodiment, key layouts are switched during password registration. In the second embodiment, a plurality of equivalent (substitute) passwords each used as a valid password are generated for pieces of information on key layouts stored in the notebook PC 100, respectively.

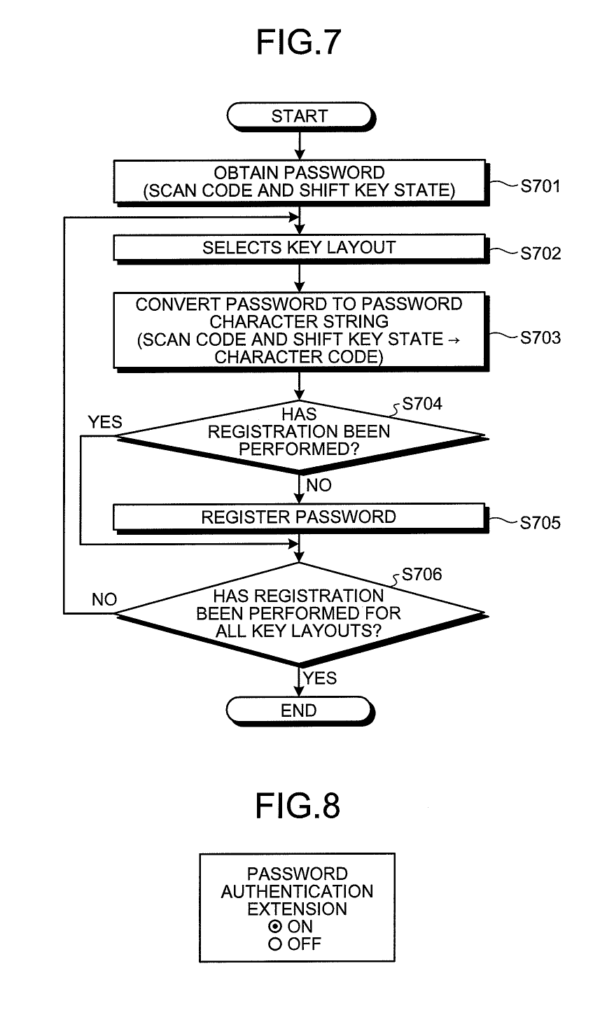

With reference to FIGS. 6 and 7, a description will then be given of a password registration process performed by the notebook PC 100. FIG. 6 is a block diagram of a software configuration for the password registration process according to the second embodiment. FIG. 7 is a flowchart of the password registration process (password registration routine) performed by the notebook PC 100. In the following, the password registration process is described as being implemented by the password registration routine performed by the CPU 201 of the notebook PC 100. However, if the password registration process is performed on an external system such as a server, the CPU of the external system performs the password registration process.

The password registration routine may be implemented by any of the system BIOS, OS, application program of the notebook PC 100 and an external system. If the password registration routine is implemented by the application program, it is necessary to inquire about a scan code corresponding to the character code of a password provided by the OS to obtain it. As in a conventional manner, a password is managed with respect to each user ID. The password registration process is described below as being performed for a certain user ID.

As illustrated in FIG. 6, the software configuration that implements the password registration routine comprises a password receiver 601, a key layout selector 602, a converter 603, and a password registration module 604. The password receiver 601 receives password data (scan data and shift key state) provided by the user (or the administrator) through the keyboard 102. The key layout selector 602 selects key layouts of various types of keyboards. The converter 603 converts the password data received through the keyboard 102 to a password character string according to each key layout. The password registration module 604 registers information based on password character strings obtained by the converter 603 for the respective types of key layouts (for example, the password character strings themselves or hash values thereof) as valid passwords corresponding to the password obtained by the password receiver 601. While FIG. 6 illustrates a registration process switch module 605 that switches between the password registration process of the second embodiment and a conventional password registration process, the registration process switch module 605 will be described later in another embodiment. The CPU 201 that performs the password registration routine implements the functions of the above modules.

The password registration process of the second embodiment will be described in detail with reference to FIG. 7.

First, a password registration screen is displayed on the flat panel display 107 to receive input of a password from the user (S701). In the second embodiment, the CPU 201 functioning as the password receiver 601 obtains the password input through the keyboard 102 as a string of a combination of a scan code and shift key state.

The CPU 201 functioning as the key layout selector 602 selects a key layout (S702). More specifically, the CPU 201 select one key layout from US layout, JIS layout, German layout, and the like. The system BIOS, OS, or application program that implements the password registration routine is provided with a table (see FIG. 5) in which a scan code and shift key state are associated with a character code with respect to each type of key layout. At S702, the CPU 201 selects one of key layouts stored in the table.

Thereafter, the CPU 201 functioning as the converter 603 converts the password (a string of a combination of a scan code and shift key state) obtained at S701 to a password character string formed of a character code string based on the table as illustrated in FIG. 5 (S703).

The CPU 201 functioning as the password registration module 604 determines whether the password character string generated at S703 has already been registered at S705 described below (S704). If the password character string has already been registered (Yes at S704), the process moves to S706. On the other hand, if the password character string is yet to be registered (No at S704), the process moves to S705.

The CPU 201 functioning as the password registration module 604 registers the password character string generated at S703 (S705). At this time, the CPU 201 may register the hash value of the password character string. Upon authenticating a password, the CPU 201 compares the hash value of the password to be authenticated with the registered hash value. If they match as a result of the comparison, the CPU 201 determines that authentication is successful.

The CPU 201 functioning as the password registration module 604 then determines, based on key layout information (see FIG. 5), whether password registration has been performed for all the key layouts (S706). If password registration has not been performed for all the key layouts (No at S706), the process returns to S702 to select a key layout for which password registration has not yet been performed. On the other hand, if password registration has been performed for all the key layouts (Yes at S706), the process ends.

As described above, according to the second embodiment, a plurality of passwords are registered for different key layouts, respectively. Accordingly, regardless of the type of the key layout of a keyboard used by the user, if a character string of a password input by the user is correct, the password matches one of the passwords registered for the key layouts, respectively. Thus, the password can be authenticated properly.

According to the first and second embodiments, (1) the user is not required to select a key layout when inputting a password, (2) the user is not required to input a password for a specific key layout (i.e., the user need not take into account the key layout of a keyboard), (3) even if registration and authentication of a password is performed (physically and sequentially) on different devices, the key layout need not match between them, and (4) a password can be authenticated properly even using a keyboard with a different key layout than that of a keyboard used for password registration.

In the following, a third embodiment of the invention will be described with reference to FIG. 8. According to the third embodiment, setup option is provided to enable/disable the function of switching key layouts during password authentication described in the first embodiment and the function of switching key layouts during password registration described in the second embodiment (hereinafter, these functions will be referred to as “password authentication extension”). FIG. 8 illustrates an example of an option setting screen to enable/disable the password authentication extension. The function of enabling/disabling the password authentication extension described below is implemented by the authentication process switch module 305 illustrated in FIG. 3 with respect to the password authentication process, and also by the registration process switch module 605 illustrated in FIG. 6 with respect to the password registration process.

In the third embodiment, if the password authentication extension is set to ON through the option setting screen as illustrated in FIG. 8, the function of switching key layouts during password authentication described in the first embodiment or the function of switching key layouts during password registration described in the second embodiment is enabled.

On the other hand, if the password authentication extension is set to OFF through the option setting screen, the function of switching key layouts during password authentication described in the first embodiment or the function of switching key layouts during password registration described in the second embodiment is disabled. In this case, in the first embodiment, the process at S402, S404, and S407 in FIG. 4 is not performed. In the second embodiment, the process at S702, S704, and S706 in FIG. 7 is not performed. That is, a conventional password authentication process or a conventional password registration process is performed with respect to a specific key layout.

According to the first and second embodiments, password authentication or password registration is performed such that a plurality of password character strings are generated each time the user inputs a password, which slightly reduces the strength of the password. Note that this can be avoided by adding one character to a password (increasing the character string length by one character).

Besides, since a key layout is not specified, there is a restriction on the function of changing a password after password authentication or password registration. For example, in the case where up to two passwords can be registered in one HDD, if the user try to change a password without specifying a key layout, all passwords may not be registered.

As described above, according to the third embodiment, whether to enable/disable the password authentication extension can be specified through the option setting screen. If the password authentication extension is set to OFF, password authentication or password registration is performed in a conventional manner, and thereby a plurality of password character strings are not generated.

The program that implements the above process executed on the notebook PC 100 or an external system such as a server is provided as being stored in advance in HDD or the like. The program may also be provided as being stored in a computer-readable storage medium, such as a compact disk read-only memory (CD-ROM), a flexible disk (FD), a compact disc-recordable (CD-R), or a digital versatile disc (DVD), in an installable or executable format. The program may also be stored in a computer connected via a network such as the Internet so that it can be downloaded therefrom via the network.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An electronic device comprising:
a receiver configured to receive data on a password input through a keyboard;
a selector configured to select one of key layouts of different keyboards;
a converter configured to convert the data on the password received through the keyboard to a password character string according to the one of the key layouts; and
an authentication module configured to determine that the password is authenticated when information based on the password character string obtained by the converter for the one of the key layouts matches information based on a registered password character string.

2. The electronic device of claim 1, wherein the data on the password received through the keyboard is a combination of a scan code and shift key state.

3. The electronic device of claim 2, further comprising a table configured to store a combination of a scan code and shift key state in association with a character code with respect to each of the key layouts, wherein
the converter is configured to refer to the table in order to convert the data to the password character string.

4. The electronic device of claim 1, wherein the information based on the password character string is a hash value calculated from the password character string.

5. The electronic device of claim 1, further comprising a, switch configured to switch between password authentication based on a specific key layout and password authentication based on the key layouts.

6. An electronic device comprising:
a receiver configured to receive data on a password input through a keyboard;
a selector configured to select one of key layouts of different keyboards;
a converter configured to convert the data on the password received through the keyboard to password character strings according to the key layouts, respectively; and
a registration module configured to register information based on each of the password character strings obtained by the converter for the key layouts as a valid password corresponding to the password received by the receiver.

7. The electronic device of claim 6, wherein the data on the password received through the keyboard is a combination of a scan code and shift key state.

8. The electronic device of claim 7, further comprising a table configured to store a combination of a scan code and shift key state in association with a character code with respect to each of the key layouts, wherein
the converter is configured to refer to the table in order to convert the data to the password character strings.

9. The electronic device of claim 6, wherein the first information based on each of the password character strings is a hash value calculated from the password character string.

10. The electronic device of claim 6, comprising a switch configured to switch between password registration based on a specific key layout and password registration based on the key layouts.
